(19) United States
(12) Patent Application Publication
(10) Pub. No.: US 2018/0250956 A1
(43) Pub. Date: Sep. 6, 2018

(54) INKJET PRINTER

(71) Applicant: Roland DG Corporation, Hamamatsu-shi (JP)

(72) Inventor: Hideyuki HASEGAWA, Hamamatsu-shi (JP)

(21) Appl. No.: 15/903,069

(22) Filed: Feb. 23, 2018

(30) Foreign Application Priority Data
Mar. 6, 2017 (JP) 2017-041704

(51) Int. Cl. B41J 11/00; B41J 2/045

(52) U.S. Cl. CPC B41J 11/002; B41J 2/2103; B41J 2/04531; B41J 2/04563

(57) ABSTRACT

An inkjet printer includes an ink tank in which an ink is stored, an ink head that ejects the ink onto a recording medium, an ink supply passage connected to the ink tank and the ink head, a light emitter that irradiates the ink ejected onto the recording medium with ultraviolet radiation, and a heat relay connected to the light emitter to transfer heat emitted by the light emitter to at least one of the ink supply passage and the ink head.

### CROSS REFERENCE TO RELATED APPLICATIONS

This application claims the benefit of priority to Japanese Patent Application No. 2017-041704 filed on Mar. 6, 2017. The entire contents of this application are hereby incorporated herein by reference.

### BACKGROUND OF THE INVENTION

### 1. Field of the Invention

The present invention relates to an inkjet printer.

### 2. Description of the Related Art

Conventionally, inkjet-type printers are known which perform printing using inks that cure when irradiated with ultraviolet radiation (which are hereinafter referred to as “ultraviolet-curable inks”). For example, an inkjet-type printer disclosed in Japanese Patent No. 5994259 includes inkjet heads that eject ultraviolet-curable inks onto a recording medium, and an ultraviolet irradiation part that irradiates the recording medium with ultraviolet radiation. The ultraviolet irradiation part has a light-emitting part that emits ultraviolet radiation, and the light-emitting part includes a plurality of light-emitting elements such as LED (Light Emitting Diode) elements.

In the printer disclosed in Japanese Patent No. 5994259, the ultraviolet-curable inks are first ejected from the inkjet heads onto the recording medium. Then, the light-emitting elements constituting the light-emitting part of the ultraviolet irradiation part irradiate the ultraviolet-curable inks ejected onto the recording medium with ultraviolet radiation. As a result, curing of the ultraviolet-curable inks ejected onto the recording medium is promoted.

In the printer disclosed in Japanese Patent No. 5994259, the light-emitting elements constituting the light-emitting part of the ultraviolet irradiation part also releases heat when emitting ultraviolet radiation. The heat emitted by the light-emitting elements is released to the outside of the printer. The heat release to the outside of the printer is not necessary. This means that energy is unnecessarily consumed.

### SUMMARY OF THE INVENTION

Preferred embodiments of the present invention provide inkjet printers that reduce unnecessary heat that is emitted by light-emitting elements that emit ultraviolet radiation.

An inkjet printer according to a preferred embodiment of the present invention includes an ink tank, an ink head, an ink supply passage, a light emitter, and a heat relay. An ink is stored in the ink tank. The ink head ejects the ink onto a recording medium. The ink supply passage is connected to the ink tank and the ink head. The light emitter irradiates the ink ejected onto the recording medium with ultraviolet radiation. The heat relay is connected to the light emitter to transfer heat emitted by the light emitter to at least one of the ink supply passage and the ink head.

According to the above-mentioned inkjet printer, the ink to be ejected from the ink heads has been preferably warmed to some extent to prevent the ink head from being clogged by the ink to be ejected from the ink head. Thus, in the above inkjet printer, when the light emitter irradiates the ink ejected onto the recording medium with ultraviolet radiation, the heat emitted by the light emitter is transferred to the heat relay and then to at least one of the ink supply passage and the ink head. As a result, the ink in the ink supply passage and the ink in the ink head are warmed, and the warmed ink is ejected from the ink head. This configuration prevents the ink head from being clogged by ink. In this way, the heat emitted by the light emitter is utilized to warm the ink to be ejected from the ink head. This allows effective use of the heat emitted by the light emitter, and reduction of unnecessary heat that is emitted by the light emitter.

According to preferred embodiments of the present invention, it is possible to provide inkjet printers that reduce unnecessary heat that is emitted by light emitters that emit ultraviolet radiation.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a front view, illustrating a printer according to of a preferred embodiment of the present invention.

FIG. 2 is a schematic diagram, illustrating an ink supply system.

FIG. 3 is a front view of ink heads, an ultraviolet irradiator and a heat accumulator.

FIG. 4 is a bottom view of the ink heads, the ultraviolet irradiator and the heat accumulator.

FIG. 5 is a schematic diagram, illustrating the connection relationship between light emitters and ink supply passages.

FIG. 6 is a block diagram of the printer.

FIG. 7 is a flowchart, showing the procedure to adjust the temperature of inks to be ejected from the ink heads.

### DETAILED DESCRIPTION OF THE PREFERRED EMBODIMENTS

Description is hereinafter made of inkjet printers according to preferred embodiments of the present invention (which may be hereinafter referred to as “printer”) with reference to the drawings. It should be understood that the preferred embodiments described herein do not limit the present invention. In addition, members and elements that have the same functions are denoted by the same reference numerals or symbols and redundant description is omitted or simplified as appropriate.

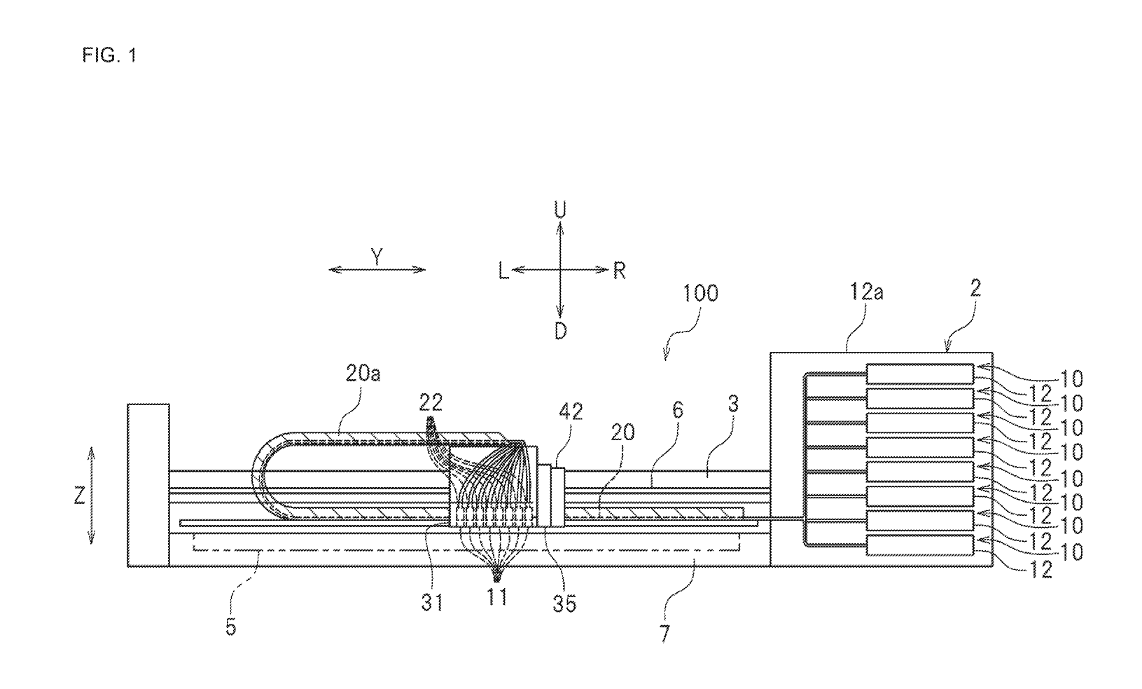

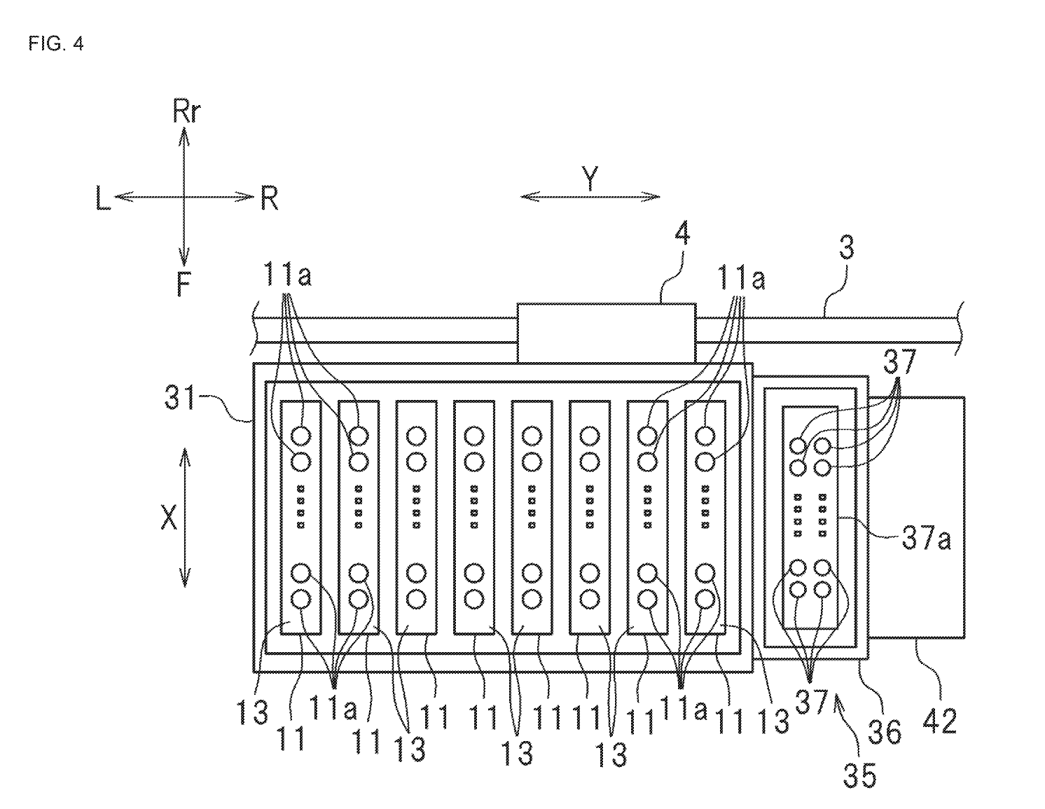

FIG. 1 is a front view of a printer 100 according to a preferred embodiment of the present invention. In the following description, the reference symbols F, Rr, L, R, U and D in the drawings represent front, rear, left, right, up and down, respectively, with respect to the printer 100 viewed from front. The reference symbol Y in the drawings represents a main scanning direction. Here, the main scanning direction Y extends in a right-left direction. The reference symbol X (refer to FIG. 4) represents a sub-scanning direction. Here, the sub-scanning direction X extends in a front-back direction and is perpendicular to the main scanning direction Y as viewed in a plan view. The reference symbol Z represents a height direction, i.e., a vertical direction. Those directions are determined for convenience of description, and do not limit the installation mode of the printer 100 or the present invention.

As shown in FIG. 1, the printer 100 is an inkjet printer. Here, the term “inkjet” refers to an inkjet using any of various continuous systems such as binary deflection systems or continuous deflection systems and various on-demand systems such as thermal systems or piezoelectric element systems. The printer 100 prints an image on a rolled recording medium 5 by moving the recording medium 5 sequentially forward (here, toward a downstream side in the sub-scanning direction X) and ejecting inks from ink heads 11 that moves in the main scanning direction Y. The recording medium 5 is an object on which an image is printed. The recording medium 5 may be any type of medium. The recording medium 5 may be paper such as plain paper or inkjet printing paper. Alternatively, the recording medium 5 may be a transparent sheet made from a resin, such as polyvinyl chloride (PVC) or polyester, or glass, or a sheet such as one made from a metal or rubber.

In this preferred embodiment, the printer 100 includes a printer main unit 2, a guide rail 3, and a carriage 4 (refer to FIG. 4). The guide rail 3 is fixed to the printer main unit 2. The guide rail 3 extends in the main scanning direction Y. As shown in FIG. 4, the carriage 4 is in engagement with the guide rail 3, and is slidably provided on the guide rail 3. Although not shown, rollers are preferably provided at opposite right and left ends of the guide rail 3. A carriage motor (not shown) is connected to one of the rollers. The roller connected to the carriage motor is rotated by the carriage motor. Here, as shown in FIG. 1, an endless belt 6 is entrained around the rollers provided at opposite ends of the guide rail 3. The carriage 4 (refer to FIG. 4) is attached to the belt 6. When the carriage motor is driven, the rollers are rotated and the belt 6 moves. Then, the carriage 4 moves in the main scanning direction Y. As described above, the carriage 4 is movable in the main scanning direction Y along the guide rail 3.

In this preferred embodiment, as shown in FIG. 1, the printer 100 includes a platen 7. The platen 7 supports the recording medium 5 during printing on the recording medium 5. The recording medium 5 is placed on the platen 7. The printing on the recording medium 5 is carried out on the platen 7. Although not shown, the platen 7 is provided with a pair of upper and lower, grid and pinch rollers. A feed motor (not shown) is connected to the grid roller. The grid roller is driven to rotate by the feed motor. When the grid roller is rotated with the recording medium pinched between the grid roller and the pinch roller, the recording medium 5 is transported in the sub-scanning direction X (refer to FIG. 4).

In this preferred embodiment, the printer 100 includes a plurality of ink supply systems 10. The ink supply systems 10 are systems that supply inks from ink tanks 12 to the ink heads 11. The ink supply systems 10 are arranged in one-to-one correspondence with the ink heads 11. The ink supply systems 10 are arranged in one-to-one correspondence with the ink tanks 12. Here, because the number of the ink heads 11 is eight, the number of the ink supply systems 10 is eight, for example. However, the number of the ink heads 11 and the number of the ink supply systems 10 are not particularly limited to this value. The plurality of ink supply systems 10 has the same configuration. Thus, in the following, the configuration of one ink supply system 10 is described.

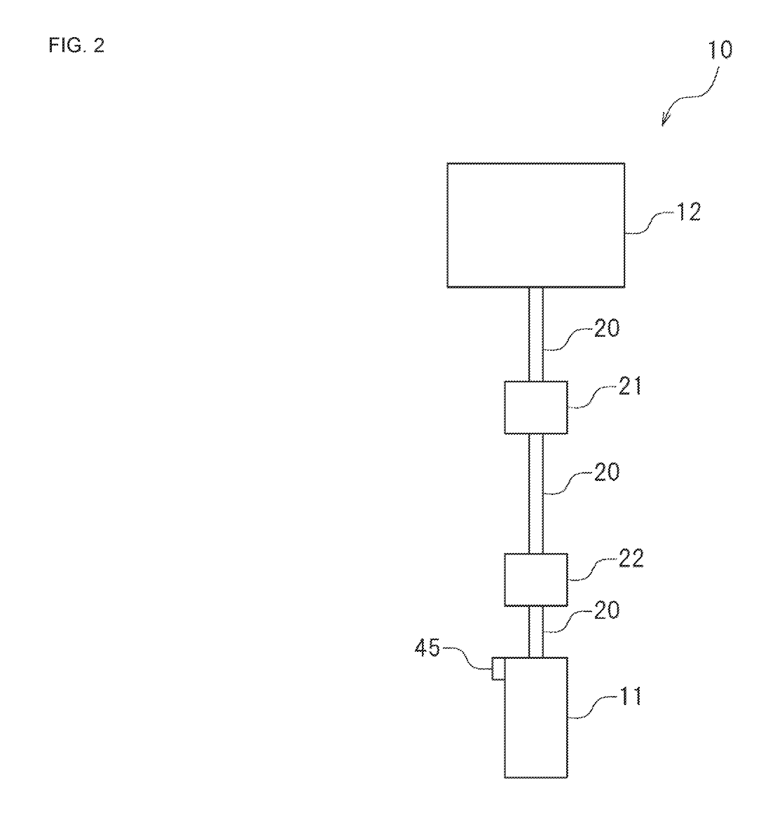

FIG. 2 is a schematic diagram, illustrating the ink supply system 10. As shown in FIG. 2, the ink supply system 10 includes the ink head 11, the ink tank 12, an ink supply passage 20, an ink heater 21, and a damper 22. In the following description, the ink tank 12 side and the ink head 11 side of the ink supply passage 20 are referred to as an “upstream side” and a “downstream side,” respectively.

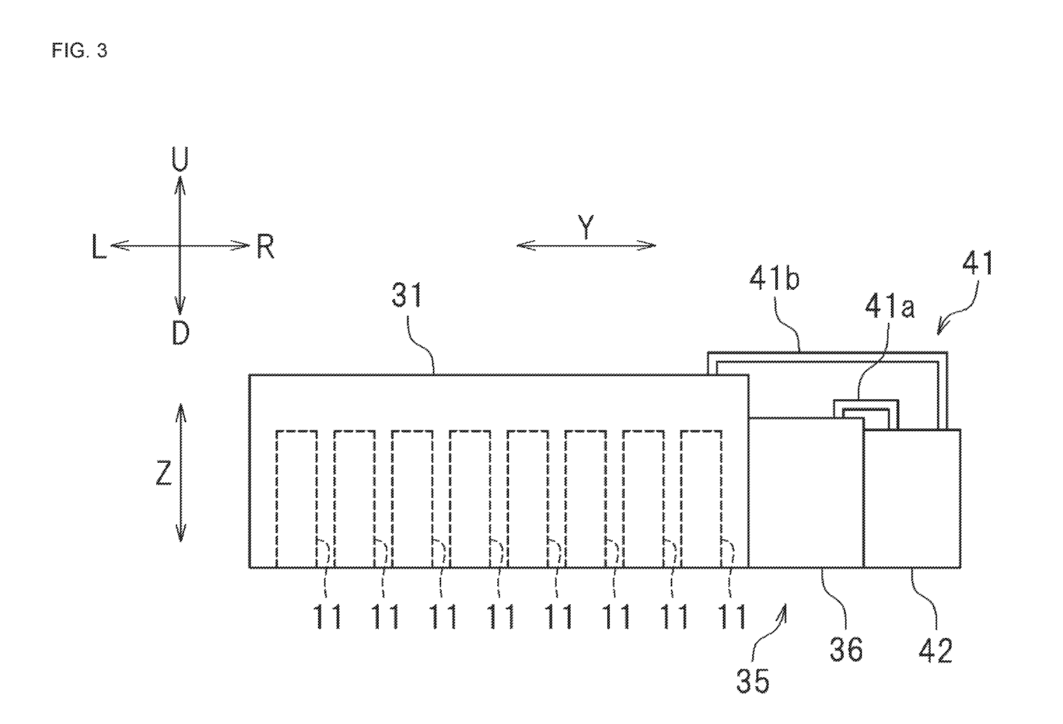

FIG. 3 is a front view of the ink heads 11, an ultraviolet irradiator 35, and a heat accumulator 42. FIG. 4 is a bottom view of the ink heads 11, the ultraviolet irradiator 35 and the heat accumulator 42. As shown in FIG. 3, the ink head 11 of each ink supply system 10 ejects an ink onto the recording medium 5 (refer to FIG. 1) placed on the platen 7. In this preferred embodiment, as shown in FIG. 4, each ink head 11 is provided in the carriage 4, and is in engagement with the guide rail 3 via the carriage 4. Each ink head 11 is movable in the main scanning direction Y along the guide rail 3. In this preferred embodiment, a plurality of nozzles 11a aligned in the sub-scanning direction X are provided in a bottom surface of each ink head 11. The ink is ejected from the plurality of nozzles 11a.

Each ink head 11 may be made from any material. For example, each ink head 11 preferably includes metal members. For example, each ink head 11 includes a nozzle plate 13 through which the nozzles 11a extend, and a cover (not shown) located above the nozzle plate 13 to cover the nozzle plate 13. A space is provided between the nozzle plate 13 and the cover, and the ink is temporarily reserved in the space. Although not shown, the cover may have an outer peripheral member exposed to the outside, and an inner peripheral member that is located inside the outer peripheral member and contacts the ink in the space between the nozzle plate 13 and the cover. In this case, the nozzle plate 13, and the outer peripheral member and the inner peripheral member of the cover may be made from a metal. However, the nozzle plate 13 and the outer peripheral member of the cover may be made from a metal, and the inner peripheral member of the cover may be made from a material other than a metal, such as a resin. Alternatively, the outer peripheral member of the cover may be made from a metal, and the nozzle plate 13 and the inner peripheral member of the cover may be made from a material other than a metal. In this preferred embodiment, at least the members that are exposed to the outside among the members of the ink head 11 are preferably partially made from a metal.

In this preferred embodiment, the printer 100 includes a carriage frame 31. The carriage frame 31 is a hollow member including an internal space therein. Here, the carriage frame 31 preferably is a rectangular member, but the carriage frame 31 is not limited to a particular shape. The carriage frame 31 is provided on a front surface of the carriage 4. In this preferred embodiment, the plurality of ink heads 11 is housed in the carriage frame 31. Here, each ink head 11 is fixed to the carriage frame 31 by fixing elements (not shown) such as bolts. The ink heads 11 are surrounded by the carriage frame 31. This configuration prevents entry of external dust or the like into the ink heads 11. In this preferred embodiment, the ink heads 11 are provided in the carriage frame 31 in such a manner that the plurality of nozzles 11a provided in a bottom surface of each ink head 11 are exposed on the underside of the carriage frame 31. Each ink head 11 is provided in the carriage 4 via the carriage frame 31. In this preferred embodiment, at least a portion of each ink head 11 is in contact with the carriage frame 31.

In this preferred embodiment, the carriage frame 31 includes metal members. However, the material of the carriage frame 31 may be made from any material. For example, the carriage frame 31 may include non-metal members.

In this preferred embodiment, the ink ejected from the plurality of nozzles 11a of each ink head 11 is an ink that cures when irradiated with ultraviolet radiation, in other words, an ultraviolet-curable ink. Here, the number of the ink heads 11 is eight, for example, as described above. Different ink heads 11 eject inks with different color tones. However, some of the ink heads 11 of the plurality of ink head 11 may eject inks of the same color tone. Each ink heads 11 may eject an ink with any color tone. The ink ejected from each ink head 11 is either a process color ink, such as cyan, magenta, yellow, light cyan, light magenta or black ink, or a special color ink, such as white, metallic or clear ink.

As shown in FIG. 2, each ink tank 12 stores an ink. In this preferred embodiment, the number of the ink tanks 12 is equal to the number of the ink heads 11, i.e., eight herein, for example. One ink head 11 is connected to one ink tank 12. The inks stored in the ink tanks 12 are supplied to the ink heads 11. The ink tanks 12 may be installed at any location. In this preferred embodiment, as shown in FIG. 1, the ink tanks 12 are detachably provided in the printer main unit 2. For example, the printer main unit 2 is provided with a housing 12a, and the plurality of ink tanks 12 is housed in the housing 12a. However, the ink tanks 12 may be detachably provided on the carriage 4 (refer to FIG. 4), for example.

As shown in FIG. 2, the inks stored in the ink tanks 12 are supplied to the ink heads 11 through the ink supply passages 20. Each ink supply passage 20 includes an upstream side end connected to an ink tank 12. Each ink supply passage 20 includes a downstream side end connected to an ink head 11. As shown in FIG. 1, in this preferred embodiment, the ink supply passages 20 are at least partially covered with a cable protective guide 20a. The cable protective guide 20a is Cable Bare (trademark), for example.

As shown in FIG. 2, the ink heaters 21 warm the inks flowing through the ink supply passages 20. In other words, the ink heaters 21 heat the inks in the ink supply passages 20. In this preferred embodiment, the ink heaters 21 warm the inks in the ink supply passages 20 to warm the inks in the ink heads 11 and the inks to be ejected from the nozzles 11a of the ink heads 11 (refer to FIG. 4). The ink heaters 21 may be installed at any location. In this preferred embodiment, the ink heaters 21 are provided on intermediate portions of the ink supply passages 20. Specifically, the ink heaters 21 are provided on upstream side portions of the ink supply passages 20. For example, the ink heaters 21 are provided on the ink supply passages 20 between the ink tanks 12 and the dampers 22. The ink heaters 21 may be any type of heaters. For example, the ink heaters 21 may be heating wires wound around the ink supply passages 20. Alternatively, the ink heaters 21 may be heating wires provided in air traps (not shown) that trap air contained in the inks.

The dampers 22 mitigate the changes in ink pressure to stabilize the ejection operation of the ink heads 11. In this preferred embodiment, the dampers 22 are provided in intermediate portions of the ink supply passages 20. Specifically, the dampers are provided in downstream side portions of the ink supply passages 20. For example, the dampers 22 are provided upstream of the ink heads 11 and downstream of the ink heaters 21. However, the dampers 22 may be located in any position. For example, the damper 22 may be directly connected to the ink heads 11.

In this preferred embodiment, as shown in FIG. 3, the printer 100 includes the ultraviolet irradiator 35. The ultraviolet irradiator 35 irradiates the inks ejected onto the recording medium 5 with ultraviolet radiation. This promotes curing of the inks ejected onto the recording medium 5. In this preferred embodiment, as shown in FIG. 4, the ultraviolet irradiator 35 is provided on the carriage 4. More specifically, the ultraviolet irradiator 35 is provided on a right surface of the carriage frame 31, in which the ink heads 11 are housed, and is provided on the carriage 4 via the carriage frame 31. The printer 100 may include any number of ultraviolet irradiators 35. For example, one ultraviolet irradiator 35 may be provided on the carriage frame 31 as in this preferred embodiment, or two ultraviolet irradiators 35 in total may be provided on both right and left sides (one on each side) of the carriage frame 31. In this preferred embodiment, the ultraviolet irradiator 35 is movable via the carriage 4 in the main scanning direction Y along the guide rail 3. The ultraviolet irradiator 35 moves in the main scanning direction Y together with the ink heads 11 when the carriage 4 moves in the main scanning direction Y.

The ultraviolet irradiator 35 may have any configuration. In this preferred embodiment, the ultraviolet irradiator 35 includes a UV frame 36, and a plurality of light emitters 37. The UV frame 36 is a hollow member having an internal space therein. Here, the UV frame 36 preferably is a rectangular member, but the UV frame 36 is not limited to a particular shape. In this preferred embodiment, the UV frame 36 is provided on the right surface of the carriage frame 31. However, the UV frame 36 may be provided on a left surface of the carriage frame 31. For example, the carriage frame 31 and the UV frame 36 may be fixed to each other by connectors such as bolts.

In this preferred embodiment, the UV frame 36 preferably includes metal members. However, the UV frame 36 may be made from any material. For example, the UV frame 36 may be made from a non-metal material. The UV frame 36 and the carriage frame 31 may be made from the same material or different materials.

The plurality of light emitters 37 is a light source that emits light (here, ultraviolet radiation). More specifically, the plurality of light emitters 37 irradiates the inks ejected onto the recording medium 5 (refer to FIG. 1) on the platen 7 with ultraviolet radiation. The light emitters 37 may be any type of light emitters. In this preferred embodiment, the light emitters are light-emitting diodes (LEDs), for example. Here, the plurality of light emitters 37 is installed in the internal space in the UV frame 36, and surrounded by the UV frame 36. More specifically, the plurality of light emitters 37 is installed in a connector 37a, and the connector 37a is fixed to the UV frame 36 via connectors (not shown) such as bolts. While the light emitters are shown to be arranged in two rows in the sub-scanning direction X with each row having four light emitters 37 in FIG. 4 for convenience of description, the number of light emitters 37 in one ultraviolet irradiator 35 and the number of rows in which the light emitters 37 are arranged in the sub-scanning direction X are not limited to particular values. In an actual ultraviolet irradiator 35, the number of rows in which the light emitters 37 are arranged in the sub-scanning direction X is one to three, for example. The number of light emitters 37 in each row is eight, ten or twelve, for example. The number of light emitters 37 and the number of rows in which the light emitters 37 are arranged in the sub-scanning direction X are selected as appropriate based on the size of the printer 100, the components of the inks and so on.

When the light emitters 37 of the ultraviolet irradiator 35 emit ultraviolet radiation, the light emitters 37 also release heat. Conventionally, the heat emitted by the light emitters 37 is released to the outside of the printer and unnecessary. Thus, the inventor of the present application considered whether there is an effective way to use the heat emitted by the light emitters 37. The inventor of the present application focused attention on the inks that are ejected from the nozzles 11a of the ink heads 11. For effective ejection of inks from the nozzles 11a of the ink heads 11, it is preferable to maintain the viscosity of the inks to be ejected from the ink heads 11 within a predetermined range. To maintain the viscosity of the inks within a predetermined range, it is preferable to maintain the temperature of the inks to be ejected from the ink heads 11 within a predetermined temperature range. Thus, the inventor of the present application came up with the idea of using the heat emitted by the light emitters 37 to warm the inks to be ejected from the ink heads 11.

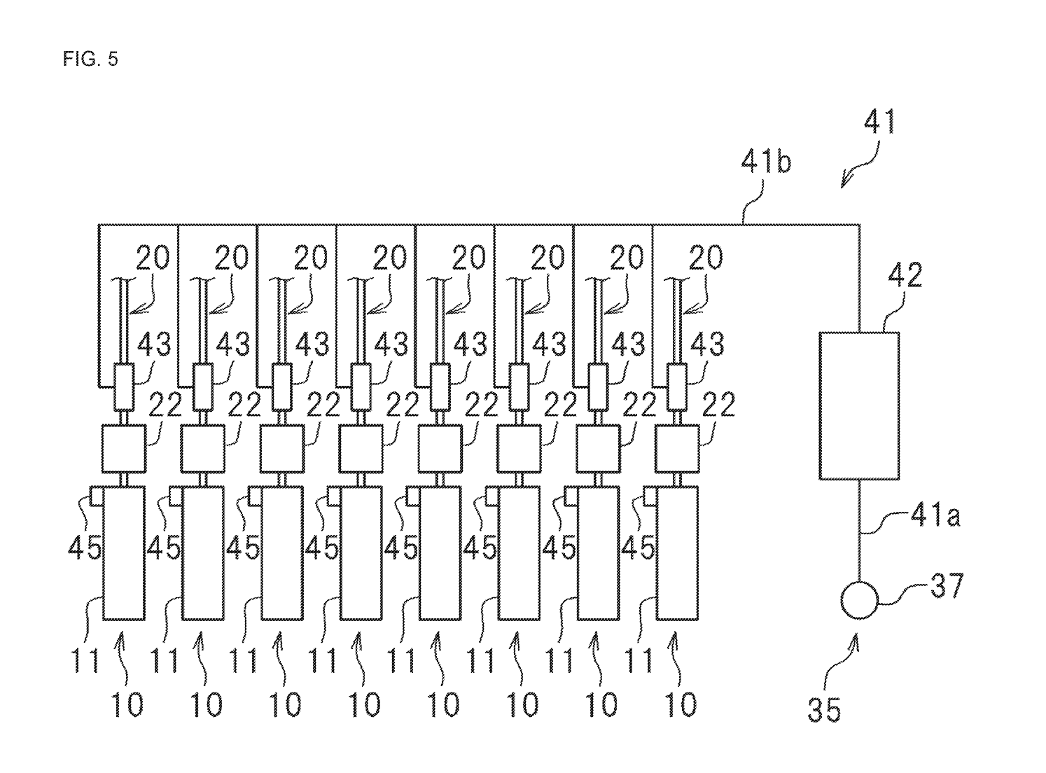

Next, the configuration by which the heat emitted by the light emitters 37 is transferred to the inks to be ejected from the ink heads 11 is described. FIG. 5 is a schematic diagram, illustrating the connection relationship between the light emitters 37 and the ink supply passages 20. In this preferred embodiment, as shown in FIG. 5, the printer 100 includes a heat relay 41, a heat accumulator 42, and heat transmitters 43. The heat emitted by the light emitters 37 is transferred to the heat relay 41. The heat relay 41 is connected to the light emitters 37 and the ink supply passages 20. In this preferred embodiment, the heat relay 41 transfers the heat emitted by the light emitters 37 to the ink supply passages 20 to warm the inks in the ink supply passages 20. As a result, warmed inks are ejected from the ink heads 11. In this preferred embodiment, as shown in FIG. 4, the light emitters 37 are fixed to the UV frame 36 via the connector 37a. For example, the heat relay 41 is connected to the connector 37a, and the heat emitted by the light emitters 37 is transferred to the heat relay 41 via the connector 37a.

The heat relay 41 may have any configuration. For example, in this preferred embodiment, the heat relay 41 includes conductive wires. However, the entire portion of the heat relay 41 may not necessarily include conductive wires. For example, some portion of the heat relay 41 may include conductive wires and another portion of the heat relay 41 may include heat-radiating fins.

As shown in FIG. 4, the heat accumulator 42 temporarily stores the heat emitted by the light emitters 37. The heat accumulator 42 is provided on the carriage 4. However, the heat accumulator 42 may be installed at any location. In this preferred embodiment, the heat accumulator 42 is installed on the right side of the UV frame 36 of the ultraviolet irradiator 35, and provided on the carriage 4 via the UV frame 36 and the carriage frame 31. However, the heat accumulator 42 may be installed on the left side of the carriage frame 31. Also, the heat accumulator 42 may not be provided on the carriage 4 but may be provided at a position spaced away from the carriage 4. In this preferred embodiment, as shown in FIG. 5, the heat accumulator 42 is provided on an intermediate portion of the heat relay 41. More specifically, the heat relay 41 includes a first heat relay 41a and a second heat relay 41b. The first heat relay 41a is connected to the light emitters 37 and the heat accumulator 42, and the second heat relay 41b is connected to the heat accumulator 42 and the ink supply passages 20.

The heat accumulator 42 may have any specific configuration. In this preferred embodiment, the heat accumulator 42 includes a block-shaped metal member. The inside of the metal member is preferably filled with a metal member. As shown in FIG. 4, the heat accumulator 42 preferably has a predetermined size. The predetermined size is generally the same as the size of the UV frame 36 or slightly smaller than the size of the UV frame 36.

In this preferred embodiment, as shown in FIG. 5, the heat transmitters 43 apply heat to the ink supply passages 20. However, the heat transmitters 43 may apply heat to the ink heads 11. The heat transmitters 43 may have any specific configuration. Here, the heat transmitters 43 are metal members provided on the ink supply passages 20, for example. For example, the heat transmitters 43 are made from aluminum. In this preferred embodiment, the second heat relay 41b of the heat relay 41 is connected to the heat transmitters 43, and the heat relay 41 is connected to the ink supply passages 20 via the heat transmitters 43.

In this preferred embodiment, the printer 100 includes temperature sensors 45. The temperature sensors 45 detect temperatures of the inks. For example, the temperature sensors 45 are provided on the ink heads 11. Here, the temperature sensors 45 detect temperatures of the inks in the ink heads 11. However, the temperature sensors 45 may be installed at any locations. For example, the temperature sensors 45 may be installed on the ink supply passages 20 or on the members provided in the ink supply passages 20. In this case, the temperature sensors 45 are preferably installed downstream of the positions where the heat transmitters 43 are provided on the ink supply passages 20. In this case, the temperature sensors 45 detect temperatures of the inks in the ink supply passage 20. The temperature sensors 45 may be any type of temperature sensors. For example, the temperature sensors 45 are thermistors.

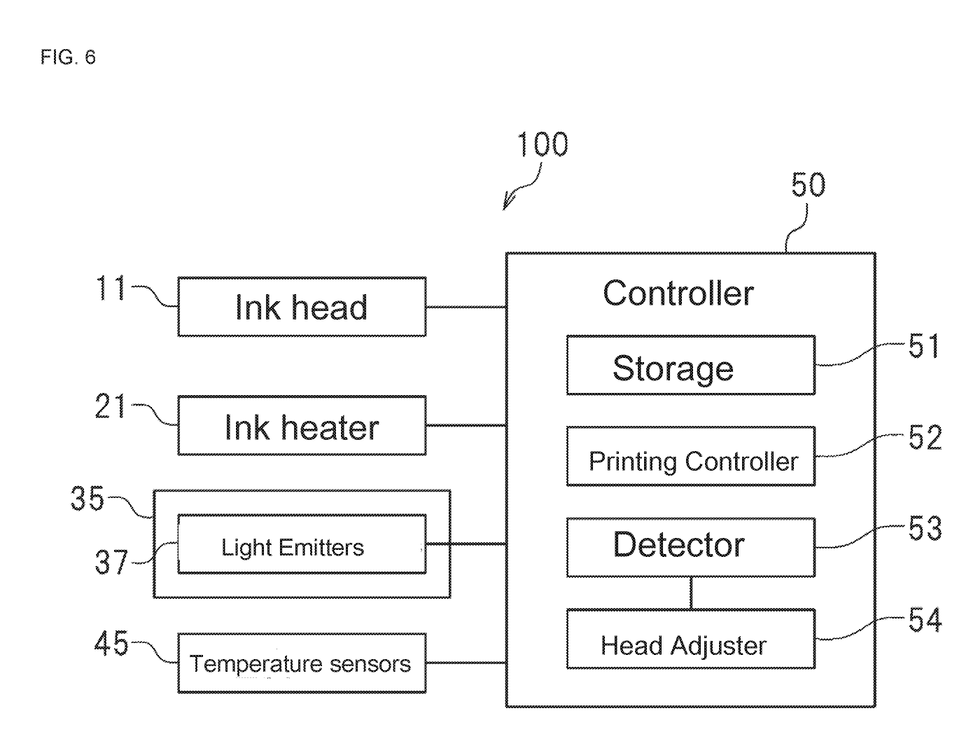

FIG. 6 is a block diagram of the printer 100. As shown in FIG. 6, the printer 100 includes a controller 50. The controller 50 adjusts the temperatures of the inks to be ejected from the ink heads 11, and controls printing on the recording medium 5. The controller 50 may have any configuration. In this preferred embodiment, the controller 50 is a microcomputer, for example. The microcomputer may have any hardware configuration, but it includes an interface (I/F) through which it receives print data and so on from an external device such as a host computer, a central processing unit (CPU) that executes instructions from control programs, a ROM (read only memory) in which programs that are executed by the CPU are stored, a RAM (random access memory) that is used as a working area in which the programs are developed, and a storage device, such as a memory, in which the program and various data are stored. The controller 50 is provided in the printer main unit 2 (refer to FIG. 1). However, the controller 50 is not necessarily provided in the printer main unit 2, and may be a personal computer or the like that is installed outside the printer main unit 2, for example. In this case, the controller 50 is communicably connected to the printer main unit 2 via a wired or wireless connection.

In this preferred embodiment, the controller 50 is electrically and communicably connected to the ink heads 11, the ink heaters 21, the ultraviolet irradiator 35 (more specifically, the light emitters 37 of the ultraviolet irradiator 35) and the temperature sensors 45, and controls the ink heads 11, the ink heaters 21, the ultraviolet irradiator 35 and the temperature sensors 45. The controller 50 controls the timings of ejection of the inks from the ink heads 11. The controller 50 controls the timing of irradiation of ultraviolet radiation from the light emitters 37 of the ultraviolet irradiator 35. The controller 50 receives information about the temperatures of the inks detected by the temperature sensors 45. Then, the controller 50 controls the heat generation rates of the ink heaters 21 based on the information about the temperatures of the inks.

In this preferred embodiment, the controller 50 is configured or programmed to include a storage 51, a printing controller 52, a detector 53, and a heat adjuster 54. Each of the above elements may be constituted of software or may be constituted of hardware. For example, each of the above elements may be implemented by a processor or incorporated in a circuit.

The printing controller 52 performs control operations necessary to print on the recording medium 5 placed on the platen 7. Specifically, the printing controller 52 sequentially moves the recording medium 5 on the platen 7 forward (here, to the downstream side in the sub-scanning direction X), and causes the nozzles 11a of the ink heads 11 to eject the inks while moving the ink heads 11 in the main scanning direction Y. Here, the ink heads move in the main scanning direction Y and the ultraviolet irradiator 35 also moves in the main scanning direction Y. Thus, when the ultraviolet irradiator 35 moves in the main scanning direction Y, the light emitters 37 of the ultraviolet irradiator 35 irradiate the inks ejected onto the recording medium 5 with ultraviolet radiation. As a result, curing of the inks ejected onto the recording medium 5 is promoted.

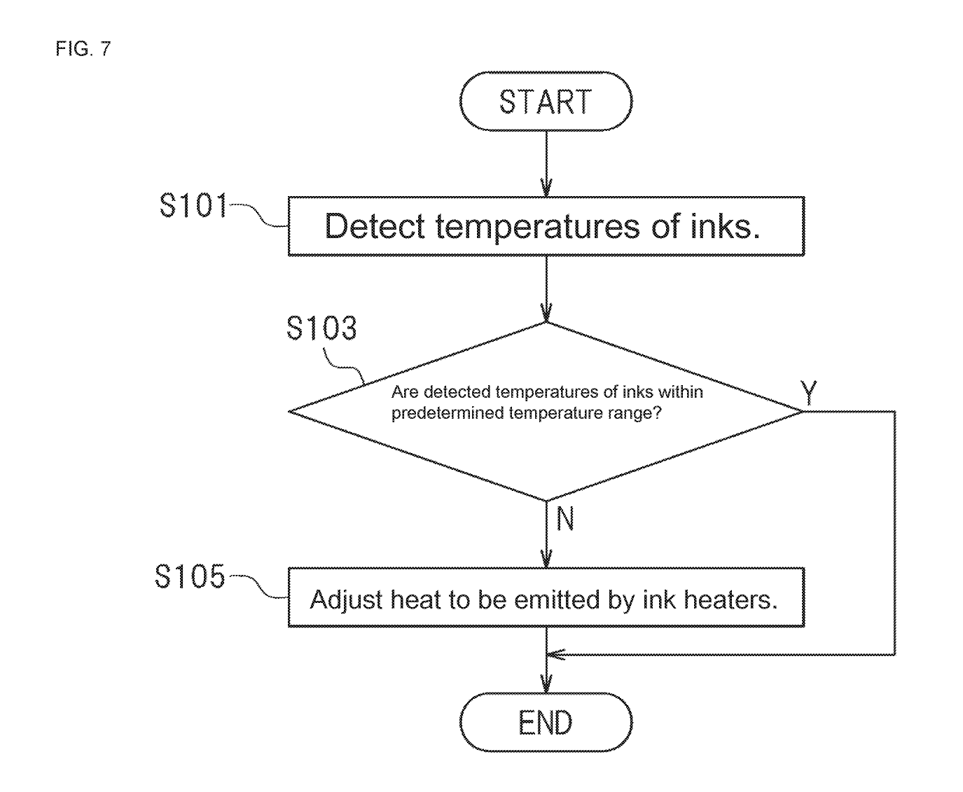

The detector 53 and the heat adjuster 54 are used to adjust the temperatures of the inks to be ejected from the ink heads 11. Next, referring to FIG. 7, the procedure to adjust the temperatures of the inks to be ejected from the ink heads 11 is described with reference to the flowchart.

First, in step S101 in FIG. 7, the detector 53 detects temperatures of the inks while printing is in progress. In this preferred embodiment, the detector 53 causes the temperature sensors 45 to detect temperatures of the inks in the ink heads 11. Then, the detector 53 estimates the temperatures of the inks to be ejected from the ink heads 11 based on the temperatures of the inks detected by the temperature sensors 45. The ink temperature detection in step S101 is performed at predetermined time intervals. The predetermined time intervals are set as appropriate by the printer 100. The predetermined time intervals are preliminarily stored in the storage 51.

Next, in step S103 in FIG. 7, the heat adjuster 54 determines whether the temperatures of the inks detected by the temperature sensors 45 are within a predetermined temperature range. Here, the predetermined temperature range is a range in which the inks are ejected properly from the nozzles 11a of the ink heads 11 without clogging the nozzles 11a. The predetermined temperature range is set as appropriate based on the printer 100 and the components of the inks. The predetermined temperature range is preliminarily stored in the storage 51. If it is determined that the temperatures of the inks detected by the temperature sensors 45 are within the predetermined temperature range, the sequential flow in FIG. 7 is terminated. If it is determined that the temperatures of the inks detected by the temperature sensors 45 are not within the predetermined temperature range, the procedure advances to step S103 in FIG. 7.

In step S103, the heat adjuster 54 adjusts the heat to be emitted by the ink heaters 21. Here, if the temperatures of the inks detected by the temperature sensors 45 are lower than the predetermined temperature range, the heat adjuster 54 controls the ink heaters 21 so that the inks in the ink supply passages 20 are warmed. If the temperatures of the inks detected by the temperature sensors 45 are higher than the predetermined temperature range, the heat adjuster 54 controls the ink heaters 21 so that the temperatures of the inks in the ink supply passages 20 are lower. In this case, the heat adjuster 54 may control the ink heaters 21 so that the ink heaters 21 emit no heat. As a result of this control in step S103, the temperatures of the inks are able to be brought closer to the predetermined temperature range.

As described above, in this preferred embodiment, the inks to be ejected from the ink heads 11 have been preferably warmed to some extent to prevent the nozzles 11a of the ink heads 11 from being clogged by the inks to be ejected from the ink heads 11. Thus, here, when the light emitters 37 irradiate the inks ejected onto the recording medium 5 with ultraviolet radiation, the heat emitted by the light emitters 37 is, as shown in FIG. 5, transferred to the heat relay 41 and then to the ink supply passages 20. As a result, the inks in the ink supply passages 20 are warmed, and the warmed inks are ejected from the ink heads 11. This configuration prevents the nozzles 11a of the ink heads 11 from being clogged by ink. In this way, in this preferred embodiment, the heat emitted by the light emitters 37 is utilized to warm the inks to be ejected from the ink heads 11. This allows effective use of the heat emitted by the light emitters 37 and reduction of unnecessary heat that is emitted by the light emitters 37.

In this preferred embodiment, the heat relay 41 preferably includes metal members. This facilitates transfer of the heat emitted by the light emitters 37 to the heat relay 41 and, consequently, facilitates warming of the inks to be ejected from the ink heads 11.

In this preferred embodiment, the heat transmitters 43 are connected to the heat relay 41 to apply heat to the ink supply passages 20. Here, the heat transmitters 43 preferably include metal members. This facilitates transfer of the heat transferred to the heat relay 41 to the ink supply passages 20 via the heat transmitters 43. This allows efficient warming of the inks in the ink supply passages 20 and, consequently, facilitates warming of the inks to be ejected from the ink heads 11.

In this preferred embodiment, the heat accumulator 42 is provided on an intermediate portion of the heat relay 41 to accumulate the heat emitted by the light emitters 37. Here, as shown in FIG. 3, the heat accumulator 42 is a block-shaped metal member installed between the first heat relay 41a and the second heat relay 41b of the heat relay 41. Thus, the heat emitted by the light emitters 37 is temporarily accumulated in the heat accumulator 42 via the first heat relay 41a. Thus, even when the light emitters 37 are not emitting ultraviolet radiation and are therefore emitting no heat, the heat accumulated in the heat accumulator 42 is transferred to the ink supply passages 20 via the second heat relay 41b. Thus, even when the light emitters 37 are emitting no heat, the inks to be ejected from the ink heads 11 are warmed with the heat from the heat accumulator 42 when some heat has been accumulated in the heat accumulator 42.

In this preferred embodiment, as shown in FIG. 2, the ink heaters 21 are provided on the ink supply passages 20 to heat the inks flowing through the ink supply passages 20. Thus, in this preferred embodiment, the inks in the ink supply passages 20 are warmed not only with heat from the light emitters 37 but also with heat emitted by the ink heaters 21. This allows efficient warming of the inks in the ink supply passages 20 and, consequently, allows efficient warming of the inks to be ejected from the ink heads 11.

In this preferred embodiment, the detector 53 of the controller 50 detects temperatures of the inks to be ejected from the ink heads 11 with the temperature sensors 45 as shown in step S101 in FIG. 7. As shown in step S103 and step S105 in FIG. 7, the heat adjuster 54 adjusts the heat to be emitted by the ink heaters 21 so that the temperatures of the inks detected by the detector 53 are able to be within a predetermined temperature range. Here, the inks ejected from the ink heads 11 are ultraviolet-curable inks, i.e., inks that cures when irradiated with ultraviolet radiation. When such ultraviolet-curable inks are warmed too much, the inks may cure and cause clogging of the nozzles 11a of the ink heads 11. Thus, in this preferred embodiment, the heat from the ink heaters 21 is controlled so that the ink temperatures are able to be within a predetermined temperature range to prevent the inks from being warmed too much and cured. This prevents the inks from being cured to cause clogging of the nozzles 11a of the ink heads 11.

In this preferred embodiment, as shown in FIG. 4, the ink heads 11 and the ultraviolet irradiator 35 including the light emitters 37 are provided on the carriage 4. Here, the heat relay 41 and the heat accumulator 42 are also provided on the carriage 4. Thus, the ink heads 11, the ultraviolet irradiator 35, the heat relay 41 and the heat accumulator 42 move in the main scanning direction Y together with the movement of the carriage 4 in the main scanning direction Y. Thus, the relative distance between the ink heads 11 and the light emitters 37 of the ultraviolet irradiator 35 does not change. This allows stable application of heat emitted by the light emitters 37 to the inks.

A preferred embodiment of the present invention has been described in the foregoing. However, the above preferred embodiment is provided for illustrative purposes only, and the present invention can be implemented in various other forms.

In the above preferred embodiment, as shown in FIG. 5, the heat transmitters 43 preferably are provided on the ink supply passages 20. The heat relay 41 is connected to the ink supply passages 20 via the heat transmitters 43 so that heat is able to be applied to the inks in the ink supply passages 20. However, the heat transmitters 43 may be provided one each on the plurality of ink heads 11, for example. In this case, the heat transmitters 43 are preferably provided on connectors (not shown) that fix the ink heads 11 to the carriage frame 31, for example. The heat relay 41 may be connected to the ink heads 11 via the heat transmitters 43 so that the heat emitted by the light emitters 37 is able to be applied to the inks in the ink heads 11. Even in this case, the heat emitted by the light emitters 37 is able to be utilized to warm the inks to be ejected from the ink heads 11. Alternatively, a configuration is possible in which the heat transmitters 43 are provided on both the ink supply passages 20 and the ink heads 11.

In the above preferred embodiment, the heat relay 41 preferably includes conductive wires, and the heat accumulator 42 is a block-shaped metal member, for example. The heat transmitters are metal members provided on the ink supply passages 20. However, the carriage frame 31, the UV frame 36 or the like may serve as the heat relay 41, the heat accumulator 42 and the heat transmitters 43, for example. For example, the portion of the carriage frame 31 that extends from the portion connected to the UV frame 36 to the portions connected to the ink heads 11, the portion of the UV frame 36 that is connected to the carriage frame 31, and connectors (not shown), such as bolts, used to fix the UV frame 36 to the carriage frame 31 may serve as the heat relay 41 and the heat accumulator 42. The heat accumulator 42 may be omitted. Fixing portions (not shown) where the ink heads 11 are fixed to the carriage frame 31 or contact portions where the ink heads 11 are in contact with the carriage frame 31 may serve as the heat transmitters 43. In this case, the carriage frame 31 and the UV frame 36 preferably include metal members. Then, the heat emitted by the light emitters 37 is transferred to the ink heads 11 via the UV frame 36 and the carriage frame 31 as the heat relay 41 and the heat accumulator 42. Thus, the heat emitted by the light emitter 37 is able to be utilized to warm the inks in the ink heads 11.

In the above preferred embodiment, the ink heaters 21 are preferably provided on the ink supply passages 20, and the inks to be ejected from the ink heads 11 are preferably warmed with the heat emitted by the ink heaters 21 as well as the heat emitted by the light emitters 37, for example. However, the ink heaters 21 may be omitted. In this case, a configuration is possible in which the inks to be ejected from the ink heads 11 are warmed only with the heat emitted by the light emitters 37.

In addition, the techniques disclosed herein can be applicable to various types of inkjet printers. In addition to so-called roll-to-roll printers in which a rolled recording medium 5 is transported, such as the printer 100 shown in the above preferred embodiment, the techniques can be also applicable to flat-bed type inkjet printers, for example. In addition, the printer 100 is not limited to a printer that is used alone as an independent printer and may be combined with other devices. For example, the printer 100 may be incorporated in another apparatus.

As described above, the storage 51, the printing controller 52, the detector 53, and the heat adjuster 54 of the controller 50 may be defined by software. In other words, a computer may be caused to implement each of the above elements and their functions by loading a computer program into it. A preferred embodiment of the present invention includes a computer program that causes a computer to function as each of the above elements. The present invention also includes a non-transitory computer readable medium in which the computer program is recorded. Each of the above elements and functions may be implemented by one processor or a plurality of processors included in the controller 50. A preferred embodiment of the present invention further includes a circuit by which the same functions as those executed by the above elements are accomplished.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An inkjet printer, comprising:
an ink tank in which an ink that is curable by ultraviolet radiation is stored;
an ink head that ejects the ink onto a recording medium;
an ink supply passage connected to the ink tank and the ink head;
a light emitter that irradiates the ink ejected onto the recording medium with ultraviolet radiation; and
a heat relay connected to the light emitter and directly physically connected to the ink head to transfer heat emitted by the light emitter to the ink head.

2. The inkjet printer according to claim 1, wherein the heat relay includes a metal block and a conductive wire.

3. The inkjet printer according to claim 2, wherein the conductive wire includes one end that is directly physically attached to a surface of the ink head.

4. The inkjet printer according to claim 2, wherein the conductive wire includes one end that is directly physically attached to the light emitter.

5. The inkjet printer according to claim 1, wherein the heat relay includes a metal block, a first conductive wire and a second conductive wire, the first conductive wire being directly physically attached to a surface of the ink head and the second conductive wire being directly physically attached to the light emitter.

6. The inkjet printer according to claim 1, wherein the heat relay is not connected to the ink supply passage.

7. The inkjet printer according to claim 1, further comprising an ink heater provided on the ink supply passage to heat the ink flowing through the ink supply passage.

8. The inkjet printer according to claim 7, further comprising:
a temperature sensor that detects a temperature of the ink in the ink head; and
a controller that controls the ink heater and the temperature sensor to adjust the heat to be emitted by the ink heater so that the temperature of the ink detected by the sensor is within a predetermined temperature range.

9. The inkjet printer according to claim 1, further comprising:
a carriage slidably provided on a guide rail that extends a main scanning direction; wherein
the ink head and the light emitter are provided on the carriage.

10. The inkjet printer according claim 9, wherein the heat relay is provided on the carriage.

11. An inkjet printer, comprising:
an ink tank in which an ink that is curable by ultraviolet radiation is stored;
an ink head that ejects the ink onto a recording medium;
an ink supply passage connected to the ink tank and the ink head; and
a light emitter that irradiates the ink ejected onto the recording medium with ultraviolet radiation; wherein
heat emitted by the light emitter is applied to the ink head to heat the ink in the ink head.

12. The inkjet printer according to claim 11, wherein the heat emitted by the light emitter is directly applied to the ink head by a direct physical connection.

13. The inkjet printer according to claim 11, further comprising a heat relay connected to the light emitter and directly physically connected to the ink head.

14. The inkjet printer according to claim 13, wherein the heat relay includes a metal block and a conductive wire.

15. The inkjet printer according to claim 14, wherein the conductive wire includes one end that is directly physically attached to a surface of the ink head.

16. The inkjet printer according to claim 14, wherein the conductive wire includes one end that is directly physically attached to the light emitter.

17. The inkjet printer according to claim 13, wherein the heat relay includes a metal block, a first conductive wire and a second conductive wire, the first conductive wire being directly physically attached to a surface of the ink head and the second conductive wire being directly physically attached to the light emitter.

18. The inkjet printer according to claim 13, wherein the heat relay is not connected to the ink supply passage.

19. The inkjet printer according to claim 11, further comprising an ink heater provided on the ink supply passage to heat the ink flowing through the ink supply passage.

20. The inkjet printer according to claim 19, further comprising:
a temperature sensor that detects a temperature of the ink in the ink head; and
a controller that controls the ink heater and the temperature sensor to adjust the heat to be emitted by the ink heater so that the temperature of the ink detected by the sensor is within a predetermined temperature range.

21. The inkjet printer according to claim 11, further comprising:
a carriage slidably provided on a guide rail that extends a main scanning direction; wherein
the ink head and the light emitter are provided on the carriage.

22. The inkjet printer according claim 21, wherein the heat relay is provided on the carriage.
